(19) United States
(12) Patent Application Publication
(10) Pub. No.: US 2008/0085965 A1
(43) Pub. Date: Apr. 10, 2008

(54) Thermosetting Powder Coating Composition

(75) Inventors: Koji Imakita, Hyogo (JP); Hirohisa Tsuda, Hyogo (JP); Hiroshi Kimoto, Hyogo (JP); Tsutomu Iijima, Hyogo (JP); Takamitsu Nishida, Hyogo (JP); Masatsune Shida, Hyogo (JP)

Correspondence Address: KRATZ, QUINTOS & HANSON, LLP, 1420 K Street, N.W., Suite 400, WASHINGTON, DC, 20005, US

(73) Assignee: KANSAI PAINT CO., LTD, Amagasaki-shi (JP)

(21) Appl. No.: 11/663,860

(22) PCT Filed: Sep. 27, 2005
(86) PCT No.: PCT/JP05/17731

§ 371 Date: Mar. 27, 2007

(30) Foreign Application Priority Data
Oct. 6, 2004 (JP) 2004-293753

(51) Int. Cl. C08K 3/32; C08K 3/10

(52) U.S. Cl. 524/417

(57) ABSTRACT

The present invention provides a thermosetting powder coating composition that is capable of forming a coating film having excellent moisture resistance, excellent corrosion resistance, etc. More specifically, the present invention provides a thermosetting powder coating composition comprising a carboxy-containing resin (A), a β-hydroxyalkylamide curing agent (B), and an anticorrosive (C) that comprises a strontium carbonate-modified aluminum phosphate.

### TECHNICAL FIELD

The present invention relates to a thermosetting powder coating composition.

### BACKGROUND ART

Powder paints are excellent coating materials from the viewpoint of environmental protection and resource conservation, since they emit no VOCs (volatile organic compounds) and have high application efficiency.

JP 2001-98212 A discloses a thermosetting powder coating composition containing a carboxy-containing resin (base resin) and β-hydroxyalkylamide (curing agent).

However, when the thermosetting powder coating composition is applied to a metal material, such as a galvanized steel sheet, iron sheet, steel sheet, or the like, the formed coating film is poor in moisture resistance, corrosion resistance, etc.

### DISCLOSURE OF INVENTION

### Problems to be Solved by Invention

An object of the present invention is to provide a thermosetting powder coating composition that is capable of forming a coating film with excellent moisture resistance, excellent corrosion resistance, etc.

### Means for Solving Problems

The present invention provides the following thermosetting powder coating composition.

1. A thermosetting powder coating composition comprising a carboxy-containing resin (A), a β-hydroxyalkylamide curing agent (B), and an anticorrosive (C) comprising a strontium carbonate-modified aluminum phosphate.

2. The thermosetting powder coating composition according to item 1, wherein the carboxy-containing resin (A) is a carboxy-containing polyester resin.

3. The thermosetting powder coating composition according to item 1, wherein the anticorrosive (C) is a mixture of strontium carbonate with an aluminum phosphate.

4. The thermosetting powder coating composition according to item 3, wherein the proportion of strontium carbonate to aluminum phosphate is 10 to 45 wt. % of strontium carbonate to 90 to 55 wt. % of aluminum phosphate.

5. The thermosetting powder coating composition according to item 3, wherein the aluminum phosphate is aluminum dihydrogen tripolyphosphate.

6. The thermosetting powder coating composition according to item 1, wherein the anticorrosive (C) has a mean particle diameter of not more than 10 μm.

The present invention is described below in detail.

The thermosetting powder coating composition of the present invention comprises a carboxy-containing resin (A), a β-hydroxyalkylamide curing agent (B), and an anticorrosive (C) comprising a strontium carbonate-modified aluminum phosphate.

Carboxy-Containing Resin (A)

In the present invention, the carboxy-containing resin (A) is used as a base resin. Examples of the carboxy-containing resin (A) include a carboxy-containing polyester resin (A1), a carboxy-containing vinyl resin (A2), and the like, which are used for epoxy-curable powder coating compositions, TGIC (triglycidyl isocyanurate)-curable powder coating compositions, etc. The carboxy-containing polyester resin (A1) and carboxy-containing vinyl resin (A2) can be used in combination.

Of the resins (A1) and (A2), the carboxy-containing polyester resin (A1) is preferable from the viewpoint of low cost and ability to form a coating film with excellent corrosion resistance.

The carboxy-containing polyester resin (A1) preferably has a number average molecular weight of 400 to 20,000, and more preferably 1,000 to 10,000. When the number average molecular weight is less than 400, the resulting coating film may have poor corrosion resistance, whereas when it is more than 20,000, the coating film may have poor smoothness. As used herein, the number average molecular weight is measured by gel permeation chromatography (GPC) using polystyrene standards.

The carboxy-containing polyester resin (A1) preferably has a softening temperature of 30 to 140° C., and more preferably 35 to 120° C. When the softening temperature is less than 30° C., the resulting coating film may have low blocking resistance, whereas when it is more than 140° C., the coating film may have poor smoothness. As used herein, the softening temperature is measured using an automatic ring-and-ball softening point tester (product of Meihosha Seisakusho) by heating a sample in a glycerol heating bath at a rate of 3° C./min and determining the temperature (° C.) at which the sample is softened and the ball drops.

The carboxy-containing polyester resin (A1) preferably has an acid value of 20 to 200 mg KOH/g, and more preferably 25 to 150 mg KOH/g. An acid value of less than 20 mg KOH/g may result in poor curability, whereas an acid value of more than 200 mg KOH/g may result in a coating film with low corrosion resistance.

Examples of the carboxy-containing polyester resin (A1) include polyester resins obtained by suitably reacting aromatic or alicyclic dicarboxylic acids, anhydrides thereof, or dimethyl esters thereof, such as phthalic acid, phthalic anhydride, isophthalic acid, terephthalic acid, dimethyl isophthalate, dimethyl terephthalate, hexahydrophthalic acid, hexahydrophthalic anhydride, tetrahydrophthalic acid, tetrahydrophthalic anhydride, etc.; with dihydric alcohols, such as (poly)ethylene glycols, (poly)propylene glycols, butylene glycol, neopentyl glycol, 1,6-hexanediol, etc.; and, if necessary, with benzoic acid or like monocarboxylic acids, trimellitic acid, trimellitic anhydride, or like tri- or higher-valent carboxylic acids or anhydrides thereof, and/or trimethylolethane, trimethylolpropane, glycerol, pentaerythritol, or like tri- or higher-hydric alcohols; in such a manner that the obtained resin has an acid value, molecular weight, and softening temperature within the above-mentioned ranges.

The carboxy-containing vinyl resin (A2) preferably has a number average molecular weight of 2,000 to 200,000, and more preferably 2,000 to 100,000. When the number average molecular weight is less than 2,000, the resulting coating film may have low corrosion resistance, whereas when it is more than 200,000, the coating film may have poor smoothness.

The carboxy-containing vinyl resin (A2) preferably has a softening temperature of 30 to 140° C., and more preferably 35 to 120° C. When the resin (A2) has a softening temperature of less than 30° C., the resulting coating film may have low blocking resistance, whereas when it has a softening temperature of more than 140° C., the coating film may have poor smoothness.

The acid value of the carboxy-containing vinyl resin (A2) is preferably 20 to 200 mg KOH/g, and more preferably 25 to 150 mg KOH/g. An acid value of less than 20 mg KOH/g may result in low curability, whereas an acid value of more than 200 mg KOH/g may result in a coating film with poor corrosion resistance.

Examples of the carboxy-containing vinyl resin (A2) include vinyl resins obtained by suitably reacting carboxy-containing radically polymerizable unsaturated monomers with other radically polymerizable unsaturated monomers by known polymerization techniques such as solution polymerization, suspension polymerization, emulsion polymerization, bulk polymerization, etc., under known polymerization conditions, in such a manner that the obtained resin has an acid value, molecular weight, and softening temperature within the above-mentioned ranges. The solvent used in the reaction, such as water, organic solvent, or the like, are removed after the reaction by vacuum distillation or like method.

Examples of carboxy-containing radically polymerizable unsaturated monomers include unsaturated acids and anhydrides thereof, such as acrylic acid, methacrylic acid, itaconic acid, maleic acid, maleic anhydride, etc.

Examples of other radically polymerizable unsaturated monomers include 2-hydroxyethyl (meth)acrylate, 3-hydroxypropyl (meth)acrylate, hydroxybutyl (meth)acrylate, and like C₂₋₈ hydroxyalkyl esters of acrylic acid or methacrylic acid; styrene, α-methylstyrene, vinyltoluene, α-chlorostyrene, and like vinyl aromatic compounds; methyl (meth)acrylate, ethyl (meth)acrylate, n-butyl (meth)acrylate, i-butyl (meth)acrylate, tert-butyl (meth)acrylate, 2-ethylhexyl (meth)acrylate, n-octyl (meth)acrylate, decyl (meth)acrylate, lauryl (meth)acrylate, stearyl (meth)acrylate, cyclohexyl (meth)acrylate, isobornyl (meth)acrylate, tricyclodecanyl (meth)acrylate, and like C₁₋₂₄ alkyl esters or cyclic alkyl esters of acrylic acid or methacrylic acid; etc.

β-Hydroxyalkylamide Curing Agent (B)

The β-hydroxyalkylamide curing agent (B) for use in the present invention reacts with carboxy groups of the carboxy-containing resin (A) described above, to thereby form a cured coating film. The β-hydroxyalkylamide curing agent (B) comprises a compound represented by Formula (1): 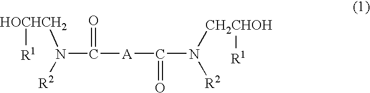
wherein R¹ is a hydrogen atom or a C₁₋₂ alkyl group; R² is a hydrogen atom, a C₁₋₅ alkyl group, or HOCH(R¹)CH₂— wherein R¹ is as defined above; and A is a divalent hydrocarbon group.

Commercially available β-hydroxyalkylamide curing agents include, for example, “PRIMID XL-552” (tradename of EMS), and the like.

It is preferable to use the β-hydroxyalkylamide curing agent (B) in such a proportion that 0.5 to 2 hydroxy groups, and preferably 0.7 to 1.5 hydroxy groups, of the curing agent (B) are present per carboxy group of the carboxy-containing resin (A). If the proportion of the curing agent (B) is outside the above range, the composition may have poor curability.

Anticorrosive (C)

The anticorrosive (C) for use in the present invention comprises an aluminum phosphate modified with strontium carbonate.

In the present invention, examples of strontium carbonate-modified aluminum phosphates include mixtures of strontium carbonate with aluminum phosphates; products obtained by baking such mixtures; strontium carbonate and aluminum phosphate, either of which is covered or treated with the other (e.g., an aluminum phosphate base material covered or treated with strontium carbonate); etc. Among these, mixtures obtained by dry-blending strontium carbonate with aluminum phosphates are preferable.

Coating films obtained by using the thermosetting powder coating composition of the present invention exhibit excellent resistance to moisture and corrosion, because the strontium carbonate component leaches out of the coating films into the interfaces between the coating films and metal substrates, when the coating films are exposed to moisture.

Examples of aluminum phosphates include aluminum dihydrogen tripolyphosphate (AlH₂P₃O₁₀.2H₂O), aluminum metaphosphate, aluminum pyrophosphate, etc. Among these, aluminum dihydrogen tripolyphosphate is preferable.

The proportion of strontium carbonate component to aluminum phosphate component in the strontium carbonate-modified aluminum phosphate is preferably 10 to 45 wt. %, and more preferably 15 to 40 wt. %, of strontium carbonate component, to 90 to 55 wt. %, and more preferably 85 to 60 wt. %, of aluminum phosphate component, based on the total weight of the two components. When the proportion of strontium carbonate component is less than 10 wt. % or more than 45 wt. %, the resulting coating film may have poor corrosion resistance.

The anticorrosive (C) preferably has a mean particle diameter of not more than 20 μm, more preferably not more than 10 μm, and even more preferably 0.1 to 5 μm. When the mean particle diameter is more than 20 μm, to impart sufficient corrosion resistance to the coating film, a large amount of anticorrosive (C) needs to be used, and the smoothness of the coating film may therefore be impaired.

The proportion of anticorrosive (C) is preferably 5 to 35 parts by weight, and more preferably 5 to 20 parts by weight, per 100 parts by weight of the total of the carboxy-containing resin (A) and β-hydroxyalkylamide curing agent (B). When the proportion of anticorrosive (C) is less than 5 parts by weight, the resulting coating film may have low corrosion resistance, whereas when it is more than 35 parts by weight, the coating film may have poor smoothness.

When necessary, the thermosetting powder coating composition of the present invention may further contain, for example, glycidyl ethers of epichlorohydrin or like epihalohydrins with aliphatic polyhydroxy compounds (e.g., glycol, glycerol, etc.); glycidyl ethers of epichlorohydrin or like epihalohydrins with alicyclic polyhydroxy compounds (e.g., hydrogenated bisphenol A and the like); glycidyl ethers of epichlorohydrin or like epihalohydrins with aromatic polyhydroxy compounds (e.g., bisphenol A, bisphenol F, novolac phenol, cresol phenol, etc.); glycidyl esters of epichlorohydrin or like epihalohydrins with aromatic polycarboxylic acid compounds (e.g., phthalic acid and the like); epoxy-containing acrylic resins; epoxidized oils; alicyclic epoxy resins; etc. Among these, glycidyl ethers of epichlorohydrin or like epihalohydrins with aromatic polyhydroxy compounds are preferable. Such glycidyl ethers include, for example, “Epon 1001”, “Epon 1002”, “Epon 1004”, and “Epon 1007” (tradenames of Shell Chemical Co.).

Also usable are known solid additives, such as solid waxes (e.g., synthetic waxes, natural waxes, etc.), solid acidic substances (e.g., adipic acid, dodecanedioic acid, etc.).

When necessary, organic coloring pigments, inorganic coloring pigments, fillers, curing catalysts, ultraviolet stabilizers, ultraviolet absorbents, fluidity adjusting agents, cissing inhibitors, anticorrosives other than those mentioned above, etc., are also usable. Precipitated barium sulfate is preferable as a filler, and precipitated barium sulfate that has a mean particle diameter of 0.4 μm to 5 μm, a pH of 8 to 9, and a specific surface area of 4.0 to 6.0 m²/g is particularly preferable from the viewpoint of moisture resistance.

The production process for the thermosetting powder coating composition of the present invention is not limited, and may be a known process. The composition can be produced, for example, by dry-blending, in a mixer or the like, the carboxy-containing resin (A), β-hydroxyalkylamide curing agent (B), anticorrosive (C), and if necessary, other components, and then heating, melting, and kneading the blend, followed by cooling, coarse grinding, pulverization, and sieving.

The thermosetting powder coating composition of the present invention can be formed into a cured coating film by applying it to a substrate by powder coating, and baking the resulting coating. The baking conditions may be, for example, at about 150° C. for about 30 minutes, or at about 180° C. for about 10 minutes.

Powder coating can be performed by known methods, such as electrostatic powder coating, frictional-electrification powder coating, fluidized-dipping coating, etc. The coating thickness is not limited, but is preferably about 30 to about 200 μm, and more preferably about 40 to about 100 μm.

Known substrates can be used without limitation, as long as they can be powder-coated. Usable substrates include, for example, zinc, iron, aluminum, magnesium, steel, alloys thereof, galvanized steel sheets, etc. Such substrates may be processed by cold-rolling, hot-rolling, molding, grinding, acid cleaning, etc. More specific examples of substrates include building materials; gas cylinders; tanks; electrical products; office equipment; bodies, exterior panels, and parts of automobiles; and the like.

It is preferable that such substrates be subjected to chemical conversion treatment with a phosphate, chromate, or the like.

### EFFECTS OF THE INVENTION

The thermosetting powder coating composition of the present invention is capable of forming a coating film that is excellent in moisture resistance, corrosion resistance, etc.

### BEST MODE FOR CARRYING OUT THE INVENTION

The following examples are given to describe the present invention in further detail.

### EXAMPLE 1

Ninety five parts by weight of carboxy-containing polyester resin (tradename “CRYLCOAT E36988”, product of DAICEL UCB Co., Ltd.; number average molecular weight: 4400; softening temperature: 104° C.; acid value: 30 mg KOH/g); 5 parts by weight of β-hydroxyalkylamide curing agent (tradename “PRIMID XL-552”, product of EMS); 45 parts by weight of titanium oxide (tradename “JR605”, product of TAYCA Corp.); and 10 parts by weight of strontium carbonate-modified aluminum phosphate (mean particle diameter: 1 to 2 μm; flat shape; mixture obtained by dry-blending 30 wt. % of strontium carbonate with 70 wt. % of aluminum dihydrogen tripolyphosphate) were mixed, and then melted and kneaded in an extruder. After cooling, pulverization was carried out using an atomizer, and the resulting powder was sieved through a 150-mesh screen, to thereby obtain a thermosetting powder coating composition.

### EXAMPLE 2

A thermosetting powder coating composition was produced in the same manner as Example 1 except that the strontium carbonate-modified aluminum phosphate was used in an amount of 5 parts by weight.

### EXAMPLE 3

A thermosetting powder coating composition was produced in the same manner as Example 1 except that the strontium carbonate-modified aluminum phosphate was used in an amount of 20 parts by weight.

### EXAMPLE 4

A thermosetting powder coating composition was produced in the same manner as Example 1 except that a carboxy-containing vinyl resin (copolymer comprising methyl methacrylate/n-butyl acrylate/styrene/methacrylic acid at a weight ratio of 58/20/10/12 as monomer components; number average molecular weight: 2300; softening temperature: 57° C.; acid value: 59 mg KOH/g) was used in place of the carboxy-containing polyester resin.

### EXAMPLE 5

A thermosetting powder coating composition was produced in the same manner as Example 1 except that, in addition to the components used in Example 1, 30 parts by weight of precipitated barium sulfate (mean particle diameter: 0.6 μm; pH 9; specific surface area: 4.5 m²/g) was used as an extender pigment.

### COMPARATIVE EXAMPLE 1

A thermosetting powder coating composition was produced in the same manner as Example 1 except that a zinc-treated aluminum tripolyphosphate (tradename “K-105”; product of TAYCA Corp.) was used in place of the strontium carbonate-modified aluminum phosphate.

### COMPARATIVE EXAMPLE 2

A thermosetting powder coating composition was produced in the same manner as Example 1 except that an aluminum tripolyphosphate (tradename “K-Ca650”; product of TAYCA Corp.) was used in place of the strontium carbonate-modified aluminum phosphate.

Coating Film Formation and Performance Test

Thermosetting powder coating compositions obtained in Examples 1 to 5 and Comparative Examples 1 and 2 were applied to the following substrates A and B to a thickness of 60 μm (when cured) by electrostatic powder coating, and heated at 160° C. for 30 minutes to form a cured coating film. The obtained coated sheets were subjected to the following tests. Table 1 shows the results.
Substrate A: cold rolled steel sheet (SPCC-SD) treated with zinc phosphate
Substrate B: hot-dip galvanized steel sheet
   [Test Methods]

Appearance: Appearance of each coating film was evaluated in terms of luster and smoothness according to the following criteria.
A: good; B: somewhat poor; C: poor; D: very poor

Gloss: Gloss was measured according to JIS K 5600-4-7 (reflectance: 60°).

Adhesion: Using a knife, eleven cuts were made in the coating film in each of the length and width directions at intervals of about 1 mm, to form a lattice pattern. Subsequently, 24 mm-wide cellophane adhesive tape was closely adhered to the cut portion and then forcibly peeled off, and the number of the remaining squares was counted.
A: 100 squares; B: 95 to 99 squares; C: 80 to 94 squares; D: not more than 79 squares

Boiling water resistance: Each coated sheet was immersed in boiling deionized water at a temperature not lower than 98° C. for 2 hours, and withdrawn. The conditions of the coating film were then evaluated in terms of appearance, gloss, and adhesion by the above methods.

Moisture resistance: Each coated sheet was placed in a moisture resistance test chamber at 50° C. and a relative humidity of 100% for 250 hours, and withdrawn. The conditions of the coating film were then evaluated in terms of appearance, gloss, and adhesion by the above methods.

Corrosion resistance: Crosscuts reaching the substrate were made in each coating film using a knife according to JIS K 5600-5-6 (general test method for paints; adhesion (crosscut method)). The resulting coated sheet was placed vertically in a salt spray tester in which 5 wt. % salt water was sprayed in an atmosphere at 35° C., and a salt water spray test was performed for 250 hours according to JIS K 5600-7-1 (neutral salt water spray resistance test method). Subsequently, 24 mm-wide cellophane adhesive tape was closely adhered to the cut portion and forcibly peeled off. Then, the maximum width (mm) of the peeled area on each side of each cut line was rated on the following scale.
A: The maximum width of the peeled area was less than 1 mm from the cut (on one side).
B: The maximum width of the peeled area was not less than 1 mm but less than 2 mm from the cut (on one side).
C: The maximum width of the peeled area was not less than 2 mm but less than 3 mm from the cut (on one side).

D: The maximum width of the peeled area was not less than 3 mm from the cut (on one side).

TABLE 1

| | | | | | | | | Comparative | |
|---|---|---|---|---|---|---|---|---|---|
| | | | Example | | | | | Example | |
| | | | 1 | 2 | 3 | 4 | 5 | 1 | 2 |
| Substrate A | Cured coating | Appearance | A | A | A | A | A | A | A |
| | film | Gloss | 90 | 91 | 85 | 92 | 75 | 90 | 90 |
| | | Adhesion | A | A | A | A | A | A | A |
| | Boiling water | Appearance | A | A | A | A | A | A | A |
| | resistance | Gloss | 86 | 85 | 75 | 90 | 73 | 84 | 82 |
| | | Adhesion | A | B | A | A | A | D | D |
| | Moisture | Appearance | A | A | A | A | A | A | A |
| | resistance | Gloss | 85 | 84 | 73 | 89 | 74 | 82 | 80 |
| | | Adhesion | A | B | A | A | A | D | D |
| | Corrosion resistance | | A | B | A | A | A | D | D |
| Substrate B | Cured coating | Appearance | A | A | A | A | A | A | A |
| | film | Gloss | 90 | 91 | 85 | 92 | 75 | 90 | 90 |
| | | Adhesion | A | A | A | A | A | A | A |
| | Boiling water | Appearance | A | A | A | A | A | A | A |
| | resistance | Gloss | 86 | 85 | 75 | 89 | 74 | 84 | 83 |
| | | Adhesion | A | B | A | A | A | D | D |
| | Moisture | Appearance | A | A | A | A | A | A | A |
| | resistance | Gloss | 84 | 82 | 70 | 90 | 75 | 81 | 80 |
| | | Adhesion | A | B | A | A | A | D | D |

| | | | | | | | |
|---|---|---|---|---|---|---|---|
| Corrosion resistance | A | B | A | A | A | D | D |

1. A thermosetting powder coating composition comprising a carboxy-containing resin (A), a β-hydroxyalkylamide curing agent (B), and an anticorrosive (C) comprising a strontium carbonate-modified aluminum phosphate.

2. The thermosetting powder coating composition according to claim 1, wherein the carboxy-containing resin (A) is a carboxy-containing polyester resin.

3. The thermosetting powder coating composition according to claim 1, wherein the anticorrosive (C) is a mixture of strontium carbonate with an aluminum phosphate.

4. The thermosetting powder coating composition according to claim 3, wherein the proportion of strontium carbonate to aluminum phosphate is 10 to 45 wt. % of strontium carbonate to 90 to 55 wt. % of aluminum phosphate.

5. The thermosetting powder coating composition according to claim 3, wherein the aluminum phosphate is aluminum dihydrogen tripolyphosphate.

6. The thermosetting powder coating composition according to claim 1, wherein the anticorrosive (C) has a mean particle diameter of not more than 10 μm.
